(19) United States
(12) Patent Application Publication
(10) Pub. No.: US 2011/0028211 A1
(43) Pub. Date: Feb. 3, 2011

(54) INFORMATION SYSTEM, INFORMATION TERMINAL, AND INFORMATION COMMUNICATION METHOD

(75) Inventors: Yuta Shiga, Tokyo (JP); Takanori Suzuki, Tokyo (JP)

Correspondence Address: CANTOR COLBURN LLP, 20 Church Street, 22nd Floor, Hartford, CT, 06103, US

(73) Assignee: DWANGO CO., LTD., Tokyo (JP)

(21) Appl. No.: 12/919,145

(22) PCT Filed: Feb. 25, 2009
(86) PCT No.: PCT/JP2009/053400

§ 371 Date: Aug. 24, 2010

(30) Foreign Application Priority Data
Feb. 29, 2008 (JP) 2008-051315

(51) Int. Cl. A63F 13/00; A63F 9/24

(52) U.S. Cl. 463/30; 463/42

(57) ABSTRACT

An information terminal may include, but is not limited to: a communication unit that receives, from a first server, a first animation and control information correlated to the first animation; a display unit that displays the first animation; and a control unit that controls the display unit to stop displaying the first animation and to start to display a second animation at a predetermined time based on the control information.

### CROSS REFERENCE TO RELATED APPLICATIONS

This is a U.S. national stage of application No. PCT/JP2009/053400, filed on 25 Feb. 2009. Priority under 35 U.S.C. §119(a) and 35 U.S.C. §365(b) is claimed from Japanese Application No. 2008-051315, filed 29 Feb. 2008, the disclosure of which is also incorporated herein by reference.

### TECHNICAL FIELD

The present invention relates to an information system, an information terminal, and an information communication method for performing information communication with multiple information terminals through a network.

Priority is claimed on Japanese Patent Application No. 2008-051315, filed Feb. 29, 2008, the content of which is incorporated herein by reference.

### BACKGROUND ART

Recently, information communication networks have been developed. It has been common that terminals used by users are constantly connected to the Internet. A network bandwidth has been increased. The amount of information, which can be distributed at one time, has been greatly increased. With the situations, an information server device connected through the Internet has distributed not only text information and image information, but also various content pieces, such as audio information and animation information. Additionally, CGM (Consumer Generated Media) has been generated by utilizing blogs, SNS (Social Networking Service), Q&A communities, animation sharing services, and the like, which enables communication by transmission and reception of information through such a network. Thus, the Internet has been used for information communication, and has been developed as an opportunity for communication.

Regarding web services that provide information through networks, generally, each user terminal performs operations of accessing URL (Uniform Resource Locator) that distributes desired information, requesting acquisition of information, acquiring distributed information, displaying or playing the acquired information, and the like (see, for example, Patent Document 1). For web services providing information through networks, the time which a user browses a website is regarded as having advertising value and economic value. For this reason, it is desirable for web service providers that users browse websites provided by the web service providers for as long as possible.

To increase the time which users browse websites, service providers occasionally take a variety of approaches such as trying to attract users by preliminarily preparing and providing valuable content, for example, by generating, collecting, and distributing more interesting content, and by distributing content for free, such as animation and music that used to be paid for, and the like.

Patent Document 1: Japanese Unexamined Patent Document, First Publication No. 2005-346119

### DISCLOSURE OF THE INVENTION

### Problems to be Solved by the Invention

However, regarding such a method for service providers to preliminarily prepare and provide valuable content, information distributed by an information server device can be predicted by users to some extent. For this reason, use of the Internet becomes monotonous, thereby boring users in some cases. Consequently, regarding animation distribution, it has been recently proposed to provide an opportunity for communication among users in various ways. For example, a service has been proposed, which displays, on an animation, comments about the animation which are posted from a user terminal, and thereby provides common experiences of viewing animations among multiple users. Additionally, a service has been proposed, which simultaneously plays the same animation or content for all users who view animations at a predetermined time.

Even these services can bore users if similar experiences are continuously provided. For this reason, service providers preferably provide interesting web services in various ways in order to increase the time which a user browses a website as much as possible. In order to add more interest to such a web service, it is preferable to provide web services, such that not only does a user terminal receive and play content previously prepared by providers, but also provide an opportunity for interactive communication among users, and different content pieces are distributed according to users who join the communication.

The present invention is made in consideration of the above situations. There is provided an information system, an information terminal, and an information communication method for providing not only information predicted by users, but also an opportunity for interactive communication among users, and thus providing more interesting services than before.

### Means for Solving the Problems

In one embodiment, an information terminal may include, but is not limited to: a communication unit that receives, from a first server, a first animation and control information correlated to the first animation; a display unit that displays the first animation; and a control unit that controls the display unit to stop displaying the first animation and to start to display a second animation at a predetermined time based on the control information.

In another embodiment, a method for an information terminal may include, but is not limited to the following processes. A first animation and control information correlated to the first animation are received from a first server. The first animation is displayed. The displaying of the first animation is stopped and a displaying of a second animation is started at a predetermined time based on the control information.

In still another embodiment, a method may include, but is not limited to the following processes. Animations and a game program correlated to the animations are transmitted from a first server to a plurality of information terminals. The animations are displayed on screens of the plurality of information terminals. The displaying of the animations is stopped and a displaying of a game animation is started at a predetermined time. The plurality of information terminals are made to simultaneously execute the game program. The game program makes a plurality of users of the plurality of information terminals play a predetermined game using the game animation. The displaying of the game animation is stopped and a displaying of the animations is started when the predetermined game ends.

### EFFECTS OF THE INVENTION

As explained above, according to the present invention, multiple information terminals initiate receiving information pieces inputted by users at a predetermined time, and transmit, to the information server device, input result information pieces based on the respective information pieces inputted by the users. In response to a request from an information terminal, the information server device transmits total information obtained by totaling the input result information pieces received from the information terminals. Accordingly, the information server device provides total information based on the information pieces simultaneously inputted by the information terminals. Thus, interactive common experiences can be provided to the users using the information terminals.

According to the present invention, each of multiple information terminals controls the display unit to switch the content screen to the input screen for receiving an information piece inputted by a user at a predetermined time and display the input screen, receives an information piece inputted in response to the input screen, and transmits the inputted information piece to the information server device. Accordingly, while content is played and multiple users browse the content for a certain period, the content screens are simultaneously switched to the input screens so that many users can be provided with common experiences at the same time.

According to the present invention, the information terminal controls the display unit to display, as an animation, the total information received from the information server device. Therefore, a user can view the total information as the animation. Accordingly, for example, when the screen is switched to the input screen while a user views an animation, and then information is inputted, total information can be provided in a series of viewing services without causing an uncomfortable feeling to the user. For example, when services, in which comments added to animation information are shared with other users, are provided, an opportunity for communication with other users can be provided by enabling comments to be added to an animation of total information.

According to the present invention, the information terminal transmits the input result information piece including the user identification information piece to the information server device. The information server device generates total information for each user identification piece received from each of the information terminals. Each user can acquire total information concerning each user, the total information including input results of other users. Therefore, an opportunity for much communication among users can be provided.

According to the present invention, the information terminal controls the display unit to display the game execution screen at a predetermined time. The information terminal transmits, to the information server device, the result of the game executed by a user inputting an information piece in response to the game. The game server device transmits, to the information terminal, total information obtained by totaling the results of games received from the plurality of information terminals. Accordingly, even when a screen suddenly switches during an operation of the information terminal, a game that attracts a user is provided on a switched screen, thereby attracting the user and preventing the user from switching to another website, and therefore enabling a longer browsing time of the user.

### BRIEF DESCRIPTION OF THE DRAWINGS

FIG. 1 illustrates a terminal configuration of an information system according to an embodiment of the present invention.

FIG. 2 illustrates an example of a player screen according to the embodiment of the present invention.

FIG. 3 illustrates an example of a total information animation screen according to the embodiment of the present invention.

FIG. 4 illustrates an example of operations of the information system according to the embodiment of the present invention.

FIG. 5 illustrates an example of a player screen according to the embodiment of the present invention.

### DESCRIPTION OF REFERENCE NUMERALS

100 totaling server device

101 total-information transmitting unit

102 totaling unit

200 information terminal

201 communication unit

202 display control unit

203 display unit

204 input unit

205 score-information transmitting unit

206 total-information acquiring unit

207 total-information reproducing unit

208 animation playing unit

209 game executing unit

300 score-information receiving server device

301 score-information receiving unit

400 distribution server device

500 comment server device

### BEST MODE FOR CARRYING OUT THE INVENTION

Hereinafter, an embodiment of the present invention is explained with reference to accompanying drawings.

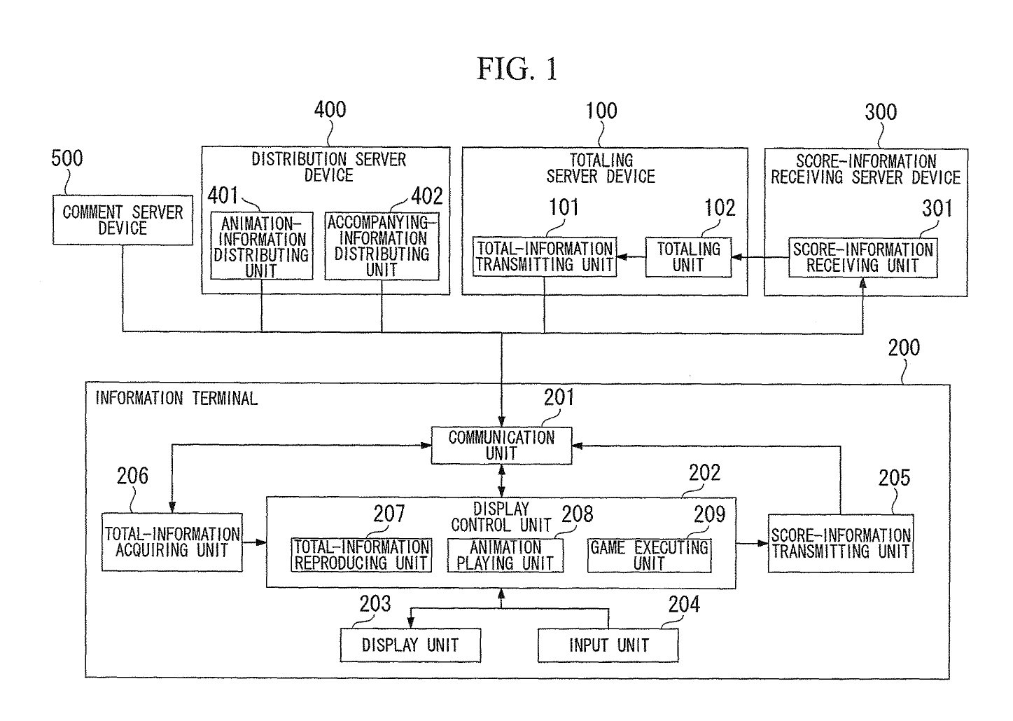

FIG. 1 is a block diagram illustrating a configuration of an information system according to the present embodiment.

An information system according to the present invention includes a totaling server device 100, an information terminal 200, a score-information receiving server device 300, a distribution server device 400, and a comment server device 500.

The information terminal 200 has a time-keeping function, an Internet browsing function, and the like. The information terminal 200 is an information terminal used by a user. The information terminal 200 performs information communication with another information device through a network. Although it is explained in the present embodiment that a PC (personal computer) is applied to the information terminal 200, another computer device, such as a PDA (Personal Digital Assistant) and a cellular telephone terminal, which includes an input unit, an output unit, a control unit, a calculating unit, and a storing unit, may be applied to the information terminal 200. Although FIG. 1 illustrates one information terminal 200 as an example, multiple computer devices, which have the same configuration as that of the information terminal 200, are connected to a network. The information terminal 200 includes a communication unit 201, a display control unit 202, a display unit 203, an input unit 204, a score-information transmitting unit 205, and a total-information acquiring unit 206.

The communication unit 201 performs, through a network, information communication with the totaling server device 100, the score-information receiving server device 300, the distribution server device 400, and the comment server device 500.

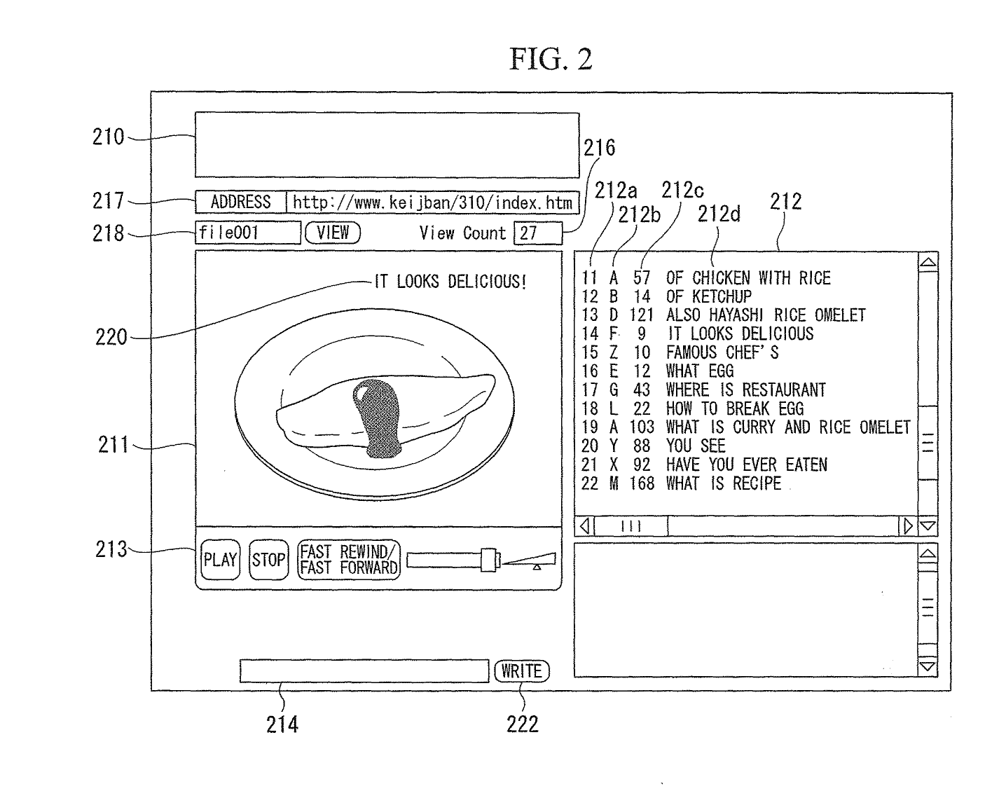

The display control unit 202 temporarily stores, in a memory region thereof, animation information that the communication unit 201 receives from the distribution server device 400 or the comment server device 500, comment information, accompanying information that will be explained later, and the like. The display control unit 202 outputs these information pieces to the display unit 203. The display control unit 202 controls the display unit 203 to display, on a specific region of the screen of the display unit 203, a player screen for displaying animation information and the like, as shown in FIG. 2. The player screen is displayed in an Internet browser screen, and provides a function by which a comment can be added while viewing an animation.

An address bar 217 shows a URL (uniform resource locator) when the information terminal 200 accesses the distribution server device 400. An animation identification information display unit 218 shows animation identification information concerning an animation to be played. A view counter 216 shows, as the browsing number of times, the total number of times a currently displayed screen has been requested for browsing. When another user plays an animation (requests browsing), the number of counts for a user browsing the same animation at that time is incremented, and the number of counts is updated and displayed.

Animation information, which is transmitted from the distribution server device 400, is played on an animation screen 211. A game screen and the like can be displayed on the animation screen 211.

A play button, a stop button, a fast-rewind button, a fast-forward button, a volume control button, a playing condition display indicating which part of the entire animation is now being played, and the like are displayed on an animation control 13. By moving the cursor over any one of the buttons and by clicking one of the buttons using a mouse, an input of an operation corresponding to the clicked button is received.

Text information that a user inputs to the input unit 204 is inputted to the input form 214 as a comment. When a writing button 222 is clicked, the comment inputted to the input form 214, a comment posted time, animation information, user identification information, and the like are transmitted to the comment server device 500.

A comment list display area 212 is an area in which a list of comments inputted by multiple users is displayed. These comments are periodically received by the communication unit 201 from the comment server device 500 and are temporarily stored in a storage area of the display control unit 202. The communication unit 201 may receive number information indicative of the total number of comments having been posted regarding the animation information, in addition to the predetermined number of comments.

A number indicative of the order in which comments have been spoken (reference numeral 212a), a name of a user who has inputted the comment (reference numeral 212b), a comment added time at which the comment has been written (reference numeral 212c), a part of the spoken comment (reference numeral 212d) are displayed on the comment list display area 212 in order of posted real time information. Such a comment is displayed in the animation screen 211 while being scrolled from the right to the left, as shown by reference numeral 220 in the animation screen 211.

An accompanying information display area 210 is an area to which information, which is different from animation information outputted by the animation screen 211, is manually outputted. The display control unit 202 temporarily stores, in the storage area thereof, accompanying information transmitted from the distribution server device 400 together with animation information, and displays the accompanying information in the accompanying information display area 210. The accompanying information is correlated to condition information indicative of a predetermined condition and includes operation information indicative of an operation that is performed if the condition is satisfied. The display control unit 202 determines, at a predetermined interval of time, whether or not the condition indicated by the condition information is satisfied. If it is determined that the condition is satisfied, the display control unit 202 performs the operation indicated by the operation information correlated to the condition information.

For example, in the present embodiment, the condition information indicates that it becomes a particular time. If the condition is satisfied, accompanying information, which is correlated to operation information indicating that a predetermined game is to be executed, is transmitted. In the present embodiment, the accompanying information includes a game program for executing such a game. The accompanying information may include operation information indicative of a procedure of downloading a game program from a predetermined URL.

Further, in the present embodiment, the condition information further indicates that a predetermined time passes after the game is initiated. If the condition is satisfied, accompanying information is transmitted, the accompanying information being correlated to operation information indicative of a procedure of displaying, in the accompanying information display area 210, character information, such as “ranking is released,” which is linked to an URL indicative of an access destination of the totaling server device 100 that distributes total information.

With reference back to FIG. 1, the display control unit 202 includes an animation playing unit 208, a game executing unit 209, and a total-information reproducing unit 207. The animation playing unit 208 controls the display unit 203 to display animation information and accompanying information which are received from the distribution server device 400, and comment information received from the comment server device 500.

As explained above, in the present embodiment, the accompanying information received by the animation playing unit 208 includes accompanying information in which operation information, which orders the game executing unit 209 to operate and which orders the display unit 203 to display a game screen, is correlated to condition information indicating that it becomes a particular time. The accompanying information further includes accompanying information in which operation information for displaying, in the accompanying information display area 210, character information that orders the display unit 203 to acquire total information indicating “ranking is released,” an URL indicating an access destination of the totaling server device 100 that distributes total information being linked to the character information, and the operation information being correlated to condition information indicating that a predetermined time passes after the game is initiated. The animation playing unit 208 determines, at a predetermined interval of time, whether or not the conditions included in the accompanying information are satisfied. If it is determined that the conditions are satisfied, the animation playing unit 208 performs the operation procedure indicated by the operation information.

When it is determined that the conditions included in the accompanying information received by the display control unit 202 are satisfied, the game executing unit 209 executes a game operation based on the game program included in the accompanying information. The game executing unit 209 controls the display unit 203 to display a game screen, and then executes the game according to the information that a user inputs to the input unit 204. In the present embodiment, the game executed by the game executing unit 209 is a game in which each time any point in the animation screen 211, which is the aforementioned player screen displayed by the display unit 203, is clicked, crack is displayed at the clicked point, and if the same point has been clicked a predetermined number of times, the screen is displayed as if the screen at the clicked point were broken. The game executing unit 209 calculates a score based on the degree of crack, the number of broken points on the screen, a time required for the screen to be broken, and the like. Then, the game executing unit 209 outputs the calculated score. The game executed by the game executing unit 209 is a game, which takes several ten seconds (from 30 seconds to 45 seconds) to end, and which can be easily executed by a mouse operation.

If it is determined that the conditions included in the accompanying information received by the animation playing unit 208 are satisfied, the total-information reproducing unit 207 displays, in the accompanying information display area 210, character information that orders acquisition of total information indicating “ranking is released,” an URL indicating an access destination of the totaling server device 100 that distributes total information being linked to the character information. If the character string indicating “ranking is released,” which is displayed in the accompanying information display area 210, is clicked, the total-information reproducing unit 207 accesses the distribution server device 400 and acquires total information display animation. Further, the total-information reproducing unit 207 controls the display unit 203 to display the acquired total information display animation. At the same time, the total-information reproducing unit 207 accesses the totaling server device 100 and transmits a request for acquiring total information, based on a program included in the total information display animation. When the total-information reproducing unit 207 receives total information transmitted from the totaling server device 100 in response to the request for acquiring the total information, the total-information reproducing unit 207 displays, on the animation screen 211 of the player screen displayed by the display unit 203, animation information indicative of the total result based on the total information display animation transmitted from the distribution server device 400 and the total information transmitted from the totaling server device 100.

The display unit 203 is a display device, such as a display. The input unit 204 is an input device, such as a keyboard and a mouse. The input unit 204 receives information inputted by a user.

The score-information transmitting unit 205 transmits score information, which is outputted when the game executed by the game executing unit 209 included in the display control unit 202 ends, to the score-information receiving server device 300 through the communication unit 201.

The total-information acquiring unit 206 transmits a request for acquiring total information to the total server device 100, and receives total information transmitted from the total server device 100 in response to the acquisition request. The display control unit 202 controls the display unit 203 to display the total information received by the total-information acquiring unit 206.

The distribution server device 400 is a computer server device that distributes animation information and accompanying information, and provides web services that display, on an animation, a comment added to the animation to be distributed. The distribution server device 400 includes an animation-information distributing unit 401 and an accompanying-information distributing unit 402. For example, the distribution server device 400 publishes, on a network, a website for displaying multiple thumbnails corresponding to multiple animation information pieces previously stored in a storing unit of the distribution server device 400. When the animation-information distributing unit 401 receives, from the information terminal 200, clicked information concerning a specific thumbnail on the published website, the animation-information distributing unit 401 transmits animation information indicated by the thumbnail to the information terminal 200. The accompanying-information distributing unit 402 can transmit accompanying information stored in a storing unit of the accompanying-information distributing unit 402, together with the animation information transmitted by the animation-information distributing unit 401. As explained above, such accompanying information includes information concerning a game program and the like.

The comment server device 500 distributes comment information correlated to the animation information that the display control unit 202 of the information terminal 200 controls the display unit 203 to display and to play.

The score-information receiving server device 300 is a server computer device that receives score information transmitted from the information terminal 200. The score-information receiving server device 300 includes a score-information receiving unit 301. The score-information receiving unit 301 receives score information pieces transmitted from multiple information terminals 200.

The totaling server device 100 is a server computer device that totals score information pieces that the score-information receiving server device 300 receives from the information terminals 200. The totaling server device 100 includes a total-information transmitting unit 101 and a totaling unit 102.

The totaling unit 102 receives multiple user identification information pieces and score information pieces, which the score-information receiving server device 300 receives from multiple information terminals 200. Based on the received information pieces, the totaling server device 100 generates total information. In the present embodiment, the total information generated by the totaling unit 102 is data in an XML (Extensible Markup Language) format, which shows score ranking in which scores indicating the results of games executed by multiple users are sorted in a descending order, and user identification information is correlated to each score.

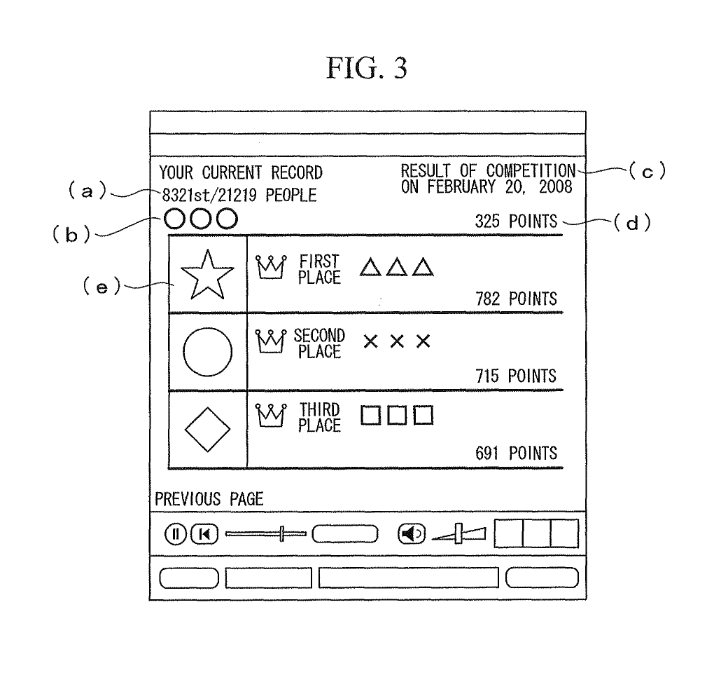

FIG. 3 illustrates an example of an animation which the total-information reproducing unit 207 displays on the animation screen 211 and which indicates the total information provided by the totaling unit 102. The total information may include a date on which the game has been executed (reference symbol (c) shown in FIG. 3), a user score for each user identification information piece (reference symbol (d) shown in FIG. 3), and a rank among all users (reference symbol (b) shown in FIG. 3).

The total information may further include, for each user identification piece, a title and a thumbnail of an animation that a user has viewed before the game executing unit 209 initiates the game while the title and the thumbnails are correlated to each other (reference symbol (e) shown in FIG. 3). For example, the totaling unit 102 generates, for each user identification piece, total information including information, such as “your current result: your rank/all users, a nickname, and a score.”

The total-information transmitting unit 101 transmits total information generated by the totaling unit 102, in response to the request for acquiring total information, which is transmitted from the information terminal 200.

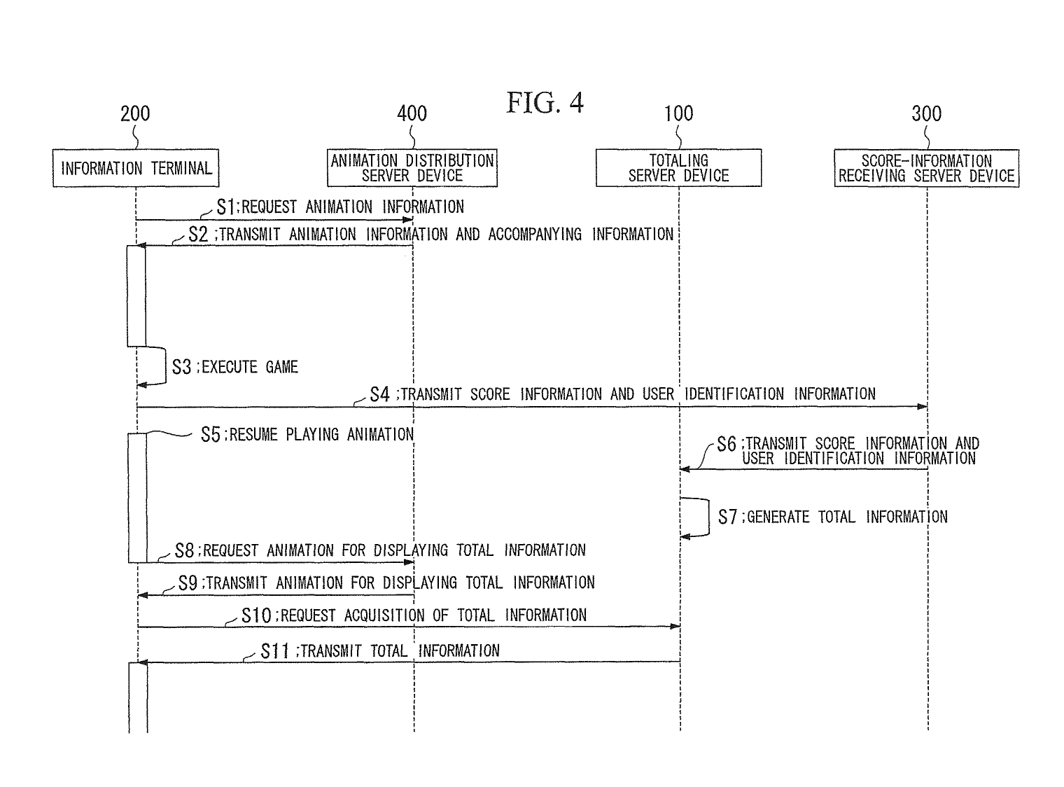

Hereinafter, an example of operations of the information system of the present invention transmitting total information to the information terminal 200 is explained with reference to FIG. 4.

Firstly, the display control unit 202 of the information terminal 200 accesses, in response to a user input, a website provided by the distribution server device 400, using an Internet browsing function of the information terminal 200. Then, the display control unit 202 transmits, to the distribution server device 400, a request for acquiring animation information (step S1). The distribution server device 400 transmits, to the information terminal 200, animation information requested by the user, and accompanying information that orders a game to be executed at a particular time and that orders a display of a link to ranking when a predetermined time passes after the game initiates (step S2).

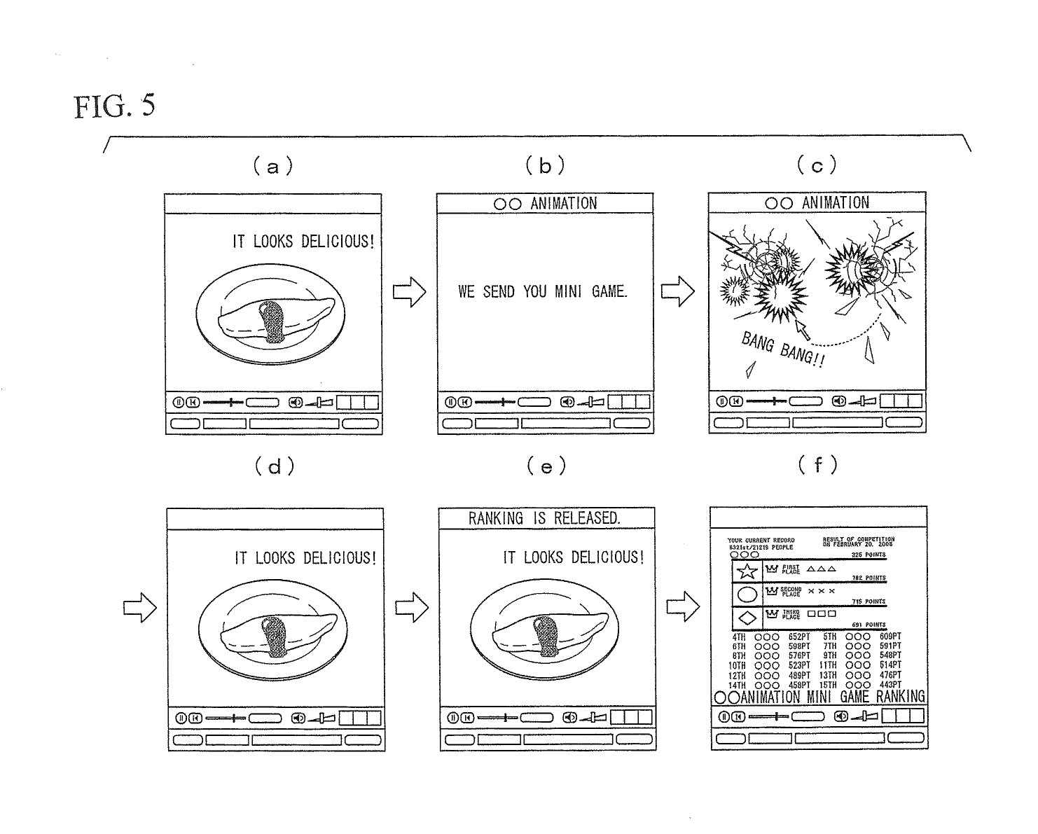

The display control unit 202 of the information terminal 200 receives, through the communication unit 201, the animation information and the accompanying information which are transmitted from the distribution server device 400. Then, the display control unit 202 stores the received information pieces in the storage area thereof. Then, the animation playing unit 208 of the display control unit 202 controls the display unit 203 to display the aforementioned player screen and controls the animation screen 211 of the display unit 203 to play the animation information received from the distribution server device 400. FIG. 5 (a) illustrates an example of the player screen that the display control unit 202 controls the display unit 203 display.

With reference back to FIG. 4, when the animation playing unit 208 of the display control unit 202 determines that a time indicated by a time keeping function of the animation playing unit 208 matches a time indicated by the condition information included in the accompanying information, the animation playing unit 208 suspends the animation displayed and played by the display unit 203. Then, the game executing unit 209 controls the display unit 203 to display a game screen on the player screen based on the game program included in the accompanying information received in step S1. FIG. 5 (b) illustrates an example of the player screen that the display control unit 202 controls the display unit 203 to display. As shown in FIG. 5 (b), the display control unit 202 controls the display unit 203 to display character information that informs initiation of a mini game.

With reference back to FIG. 4, the game executing unit 209 executes a game program included in the accompanying information (step S3). The input unit 204 receives information inputted by a user according to a game displayed by the display unit 203. The game executing unit 209 proceeds with a game according to the inputted information and executes the game. FIG. 5 (c) illustrates an example of the player screen that the display control unit 202 controls the display unit 203 to display. As shown in FIG. 5 (c), the game executing unit 209 controls the display unit 203 to display a mini game and executes the game. In the mini game, the screen is displayed as if the displayed screen is broken by cricking a button with the mouse.

With reference back to FIG. 4, when the game executed in step S3 ends, the game executing unit 209 calculates a score of the game and controls the display unit 203 to display the score. Then, the score-information transmitting unit 205 transmits the score information calculated by the game executing unit 209 and the user identification information to the score-information receiving server device 300 (step S4). Then, when the game ends, the display control unit 202 of the information terminal 200 resumes playing the animation, which has been suspended when the game has been initiated in step S3 (step S5). FIG. 5 (d) illustrates an example of the player screen that the display control unit 202 controls the display unit 203 to display.

With reference back to FIG. 4, when the score-information receiving server device 300 receives the score information pieces transmitted from the multiple information terminals 200 connected thereto through a network, the score-information receiving server device 300 transfers the received information pieces to the totaling server device 100 (step S6). In this case, when it becomes a predetermined time after the game ends, the score-information receiving server device 300 may stop reception of score information pieces and reject reception of the score information pieces transmitted from the information terminals 200.

When the totaling unit 102 of the totaling server device 100 receives multiple user identification information pieces and score information pieces which are transferred from the score-information receiving server device 300, the totaling unit 102 sorts the user identification information pieces in a descending order based on the scores indicated by the received score information pieces. Then, the totaling unit 102 generates, as total information, ranking data in which a user identification information piece with a higher score is ranked higher (step S7).

Then, when the display control unit 202 of the display control unit 200 determines that a predetermined time passes after the game ends based on the accompanying information received in step S1, the display control unit 202 controls the accompanying information display area 210 of the display unit 203 to display link information correlated to character information indicating “ranking is released.” FIG. 5 (e) illustrates an example of the player screen that the display control unit 202 controls the display unit 203 to display.

With reference back to FIG. 4, if the character string indicating “ranking is released” displayed in the accompanying information display area 210 is clicked by the input unit 204, the total-information acquiring unit 206 transmits, through the communication unit 201, a request for acquiring a total information display animation including user identification information to the distribution server device 400 (step S8). When the distribution server device 400 receives the request for acquiring the total information display animation from the information terminal 200, the distribution server device 400 transmits animation information for displaying total information to the information terminal 200 (step S9). Then, the total-information reproducing unit 207 transmits, to the totaling server device 100, a request for acquiring total information corresponding to user identification information concerning a user of the information terminal 200 based on a program included in the total information display animation transmitted from the distribution server device 400 (step S10). The total-information transmitting unit 101 of the total server device 100 acquires, from the totaling unit 102, the total information corresponding to the user identification information included in the request for acquiring the total information, which is received from the information terminal 200 in step S10. Then, the total-information transmitting unit 101 transmits the acquired total information to the information terminal 200 (step S11).

Then, the total-information reproducing unit 207 of the display control unit 202 controls the display unit 203 to display an animation indicating the total result based on the total display animation transmitted from the distribution server device 400 and the total information transmitted from the total server device 100. FIG. 5 (f) illustrates an example of the player screen that the display control unit 202 controls the display unit 203 to display. The animation displayed by the display unit 203 shows user identification information pieces corresponding to top three scores in large size, and shows therebelow user identification information pieces corresponding to the fourth score and low ranked scores. Then, for example, the user identification information pieces and the score information pieces, which are displayed on the screen, are scrolled up so that user identification pieces corresponding to lower scores down to the lowest scores are sequentially displayed. Similar to normal animation information, a comment may be added to the animation information.

If there is no user input in step S3, the process of transmitting the user identification information piece and the score information piece, which is performed in step S4 by the score-information transmitting unit 205, may not be performed to decrease process data.

Although it has been explained in the present embodiment that the game executed by the game executing unit 209 is the game that displays the screen as if the screen is broken when the screen is clicked and that calculates a score based on the degree of the breaking, another game may be used. For example, if an animation viewed by the animation playing unit 208 relates to an animal, a game related to the animal may be provided.

It has been explained in the present embodiment that multiple information terminals execute games at a predetermined time, and transmits scores of the executed games to the information server device, and then the information server device totals the scores. However, for example, an input for a questionnaire, information concerning bidding on Internet auction, and the like may be inputted to an information terminal at a predetermined time, so that these information pieces are transmitted to the information server and totaled.

It has been explained in the present embodiment that the accompanying information for giving notification indicating “ranking is released” when a predetermined time passes after a game ends is transmitted in step S1. However, if the information terminal 200 accesses the information server device at a predetermined interval of time, the total server device 100 may notify the information terminal 200 of completion of the totaling process when the totaling unit 102 of the totaling server device 100 finishes a totaling, so that the display unit 203 of the information terminal 200 displays the notification indicating “ranking is released.”

When score information pieces are received from multiple users and are totaled, loads of the process of receiving score information pieces and the process of totaling the score information pieces can be distributed by the configuration in which the totaling server device 100 includes the functional unit including the total-information transmitting unit 101 and the totaling unit 102, and the score-information receiving server device 300 includes the score-information receiving unit 301, as in the present embodiment. However, the total-information transmitting unit 101, the totaling unit 102, and the score-information receiving unit 301 may be included in the same information server device. When such a totaling process is performed, a function of a memory cash server, which manages information in a memory by correlating keys and values, may be used in order to decrease a load on CPU and to achieve faster operation.

Each functional unit explained in the present embodiment is not limited to the aforementioned configuration. A system provider can flexibly configure the functional units in consideration of the number of system users, network environments, a support system, existing hardware resources of a manager, and the like.

As explained above, according to the present invention, each of multiple information terminals initiates receiving information inputted by a user at a predetermined time, and transmits, to the information server device, an input result information piece based on the information inputted by the users. In response to a request from an information terminal, the information server device transmits total information obtained by totaling the input result information pieces received from the information terminals. Accordingly, the information server device provides total information based on the information pieces simultaneously inputted by the information terminals at the same time. Thus, interactive common experiences among the users of the respective information terminals can be provided.

As explained above, according to the present embodiment, animation screens of multiple information terminals 200 that are viewing animations are changed to a game screen at a predetermined time. Then, the total server device 100 totals score information pieces concerning the executed game through the score-information receiving server device 300. Then, the totaling server device 100 transmits the results of totaling the score information pieces to the information terminals 200. Accordingly, the information terminals 200 that have been viewing different animations execute the same game at the same time. Then, each of the information terminals 200 acquires total information concerning score information pieces of the information terminals 200 which has executed the game. Then, each of the information terminals 200 controls the display unit 203 to display the total information. Accordingly, multiple users who view animations can be provided with an opportunity for communication among the users. Compared with one way transmission of predetermined information performed by the distribution server device 400, mutual information communication between the information terminal 200 and the distribution server device 400 is performed. For this reason, multiple users can be provided with interactive common experiences compared to the conventional case. Therefore, such pressure attracts users, thereby achieving a longer time which a user browses a website published by the distribution server device 400.

The program for implementing the functions of the processing units according to the present invention may be stored in a computer-readable recording medium, so that information is provided by a computer system reading and executing the program stored in the recoding medium. The “computer system” includes an OS and hardware, such as a peripheral device. The “computer system” includes a WWW system that includes home page providing environments (or display environments). The “computer-readable recording medium” includes: a portable medium, such as a flexible disk, a magnetic optical disc, a ROM, or a CD-ROM; and a storage device, such as a hard disk included in the computer system. The “computer-readable recording medium” further includes a medium that stores a program for a predetermine time, such as a random access memory (RAM) included in a computer system that becomes a server or a client when a program is transmitted through a network such as the Internet, or a communication line such as a telecommunication line.

The program may be transmitted from a computer system that stores the program in a storage device and the like to another computer system through a transmission medium or through a transmitted wave in a transmission medium. The “transmission medium” that transmits the program indicates a medium that has a function of transmitting information, such as a network (communication network) such as the Internet, and a communication link (communication line) such as a telecommunication line. Further, the program may be a program that implements a part of the aforementioned functions. Moreover, the program may be a program that can implement the aforementioned functions by combining programs already stored in the computer system, in other words, a differential file (differential program).

### INDUSTRIAL APPLICABILITY

The present invention is applicable to web services that provide information through a network.

1-7. (canceled)

8. An information terminal comprising:
a communication unit that receives, from a first server, a first animation and control information correlated to the first animation;
a display unit that displays the first animation; and
a control unit that controls the display unit to stop displaying the first animation and to start to display a second animation at a predetermined time based on the control information.

9. The information terminal according to claim 8, wherein
the control information comprises a game program that orders the control unit to have a first user of the information terminal play a predetermined game using the second animation, and
the control unit executes the game program at the predetermined time based on the control information.

10. The information terminal according to claim 9, wherein the second animation is a game animation for the first user to play the predetermined game.

11. The information terminal according to claim 8, wherein
the order information orders the control unit to control the communication unit to download a game program from a second server, the game program ordering the control unit to have a first user of the information terminal play a predetermined game using the second animation, and
the control unit executes the game program at the predetermined time based on the order information.

12. The information terminal according to claim 9, wherein
the order information further comprises condition information concerning the predetermined time,
the control unit determines whether or not it becomes the predetermined time indicated by the condition information, and
the control unit executes the game program when it is determined that it becomes the predetermined time.

13. The information terminal according to claim 9, wherein the communication unit transmits, to a third server, information of a result of the predetermined game played by the first user when the predetermined game ends.

14. The information terminal according to claim 13, wherein the communication unit transmits, to the third server, the information of the result and a first identifier of the first user correlated to the information of the result.

15. The information terminal according to claim 9, wherein the control unit controls the display unit to stop displaying the second animation and to start to display the first animation when the predetermined game ends.

16. The information terminal according to claim 13, wherein
the condition information orders the control unit to control the display unit to display, when a predetermined time interval passes after the predetermined game ends, message information indicating that ranking information is available from the third server, the ranking information indicating a rank of the first user among a plurality of users of different information terminals, the plurality of users simultaneously playing the predetermined game at the predetermined time, and the rank being calculated by the third server based on the information of the result, and
the control unit controls the display unit to display the message information based on the condition information.

17. The information terminal according to claim 16, wherein
the message information comprises address information of the third server,
the information terminal further comprises:
an acquiring unit that acquires the ranking information from the third server using the address information, and
the control unit controls the display unit to display the ranking information acquired by the acquiring unit.

18. The information terminal according to claim 16, wherein
the control unit controls the display unit to stop displaying the second animation and to start to display the first animation when the predetermined game ends, and
the control unit controls the display unit to display the message information with the first animation based on the condition information.

19. The information terminal according to claim 17, wherein
the control unit controls the communication unit to receive, from the first server, a third animation for displaying the ranking information, and
the control unit controls the display unit to display the ranking information using the third animation.

20. The information terminal according to claim 8, wherein
the communication unit receives comment information from a fourth server,
the comment information comprises a comment on the first animation, the comment having been posted to the fourth server, and
the control unit controls the display unit to display the first animation with the comment information.

21. A method for an information terminal, comprising:
receiving, from a first server, a first animation and control information correlated to the first animation; displaying the first animation; and stopping displaying the first animation and starting to display a second animation at a predetermined time based on the control information.

22. The method according to claim 21, further comprising:
executing a game program at the predetermined time, the game program being included in the control information, and the game program making a first user of the information terminal play a predetermined game using the second animation; and
stopping displaying the second animation and starting to display the first animation when the predetermined game ends.

23. The method according to claim 22, further comprising:
transmitting information of a result of the predetermined game to a second server within a predetermined period after the predetermined game ends;
displaying message information with the first animation when a predetermined time interval passes after the predetermined game ends, the message information indicating that ranking information is available from the second server, the ranking information indicating a rank of the first user among a plurality of users of different information terminals, the plurality of users simultaneously playing the predetermined game at the predetermined time, the rank being calculated by the second server based on the information of the result, and the message information comprising address information of the second server; and
acquiring the ranking information from the second server using the address information.

24. The method according to claim 21, further comprising:
receiving comment information from a third server, the comment information comprising a comment on the first animation, the comment having been posted to the third server, and the comment information being displayed with the first animation.

25. A method comprising:
transmitting animations and a game program correlated to the animations from a first server to a plurality of information terminals;
displaying the animations on screens of the plurality of information terminals;
stopping displaying the animations and starting to display a game animation at a predetermined time;
making the plurality of information terminals simultaneously execute the game program, the game program making a plurality of users of the plurality of information terminals play a predetermined game using the game animation; and
stopping displaying the game animation and starting to display the animations when the predetermined game ends.

26. The method according to claim 25, further comprising:
transmitting information pieces of results of the predetermined game from the plurality of information terminals to a second server within a predetermined period after the predetermined game ends;
generating, by the second server, ranking information based on the information pieces of the results, ranking information indicating ranks of the plurality of users;
transmitting a request for the ranking information from a first information terminal of the plurality of information terminals to the second server; and
transmitting the ranking information from the second server to the first server in response to the request.

27. The method according to claim 26, further comprising:
displaying message information with the animations on the screens of the plurality of information terminals when a predetermined time interval passes after the predetermined game ends, the message information indicating that the ranking information is available from the second server.
